(19) United States
(12) Patent Application Publication
(10) Pub. No.: US 2010/0166978 A1
(43) Pub. Date: Jul. 1, 2010

(54) METHOD FOR MANUFACTURING EYEGLASSES

(75) Inventor: Olavi Nieminen, Vanhalinna (FI)

Correspondence Address: OLIFF & BERRIDGE, PLC, P.O. BOX 320850, ALEXANDRIA, VA, 22320-4850, US

(73) Assignee: THETA OPTICS LTD OY, Lieto (FI)

(21) Appl. No.: 12/667,139

(22) PCT Filed: Jul. 3, 2008
(86) PCT No.: PCT/FI2008/050404

§ 371 Date: Dec. 29, 2009

(30) Foreign Application Priority Data
Jul. 4, 2007 (FI) 20075505

(51) Int. Cl. B05D 5/06; B29D 11/00; B05D 3/06

(52) U.S. Cl. 427/553; 427/164

(57) ABSTRACT

A method for manufacturing eyeglasses. In the method a preform for the eyeglasses is injection moulded of transparent plastic, the preform comprising lens areas and a frame connecting them and arranged seamlessly thereto, and a computer-controlled printing is performed on the preform for providing one or more functional and/or decorative coatings, the printing being directed at least to the lens areas. The computer-controlled printing in also directed to the frame. Thus, the outline of a frame area is printed. In a second embodiment of the invention, there is injection moulded an eyeglass frame that forms a continuous, endless and elastic component around the lens holes. The lens holes are compressible around the lenses fitted in the lens holes. Computer-controlled printing is directed to the frame for providing one or more functional and/or decorative coatings.

### BACKGROUND OF THE INVENTION

The invention relates to a method for manufacturing eyeglasses.

The invention also relates to a method for manufacturing eyeglasses, in which method frames of the eyeglasses are injection moulded.

There are known a number of methods for manufacturing eyeglasses. It should be noted that the term “eyeglasses” refers here not only to spectacles but also to protective eyewear and sunglasses.

As it is known, manufacturing of eyeglasses is a slow and handwork-intensive process, due to which manufacturing costs of the eyeglasses are high.

### BRIEF DESCRIPTION OF THE INVENTION

The object of the present invention is to provide a novel and improved method for manufacturing eyeglasses.

The method of the invention is characterized by injection moulding a preform for eyeglasses of transparent plastic material, the preform comprising lens areas and a frame in seamless arrangement therewith that connects them, and by performing a computer-controlled printing on the preform for providing one or more functional and/or decorative coatings, the printing being directed at least to the lens areas.

A second method of the invention is characterized by injection moulding an eyeglass frame that forms a continuous, endless and elastic component around the lens holes, the lens holes being compressible around the lenses fitted in the lens holes, and by performing a computer-controlled printing for providing one or more functional and/or decorative coatings.

An advantage with the invention is that manufacturing of eyeglasses is quick and readily automated. A further advantage is that the method of the invention enables, for instance, a photochromatic IR block function (prevention from IR radiation), a UV block function (prevention from UV radiation), an AR function (antireflective, reflection-free) and/or a decorative function to be included in the eyeglasses in a flexible and completely customized manner.

### BRIEF DESCRIPTION OF THE DRAWINGS

Some embodiments of the invention will be described in greater detail in the attached drawings, in which

FIGS. 1a and 1b are schematic front and top views of eyeglasses manufactured in accordance with the method of the invention,

FIG. 2 is a schematic front view of second eyeglasses manufactured in accordance with the method of the invention,

FIGS. 3a and 3b are schematic front views of third eyeglasses manufactured in accordance with the method of the invention,

FIG. 4 is a schematic top view of a part of eyeglasses manufactured in accordance with the method of the invention,

FIG. 5 is a schematic front view of fourth eyeglasses manufactured in accordance with the method of the invention,

FIG. 6 is a schematic side view of a connector construction,

FIG. 7 is a schematic side view of a second connector construction,

FIG. 8 is a schematic front view of a third connector construction,

FIGS. 9a and 9b show schematically principles of some steps in the methods of some embodiments in accordance with the invention,

FIG. 10 is a schematic front view of a part of eyeglasses manufactured in accordance with the method of the invention,

FIG. 11 is a schematic top view of a part of second eyeglasses manufactured in accordance with the method of the invention,

FIG. 12 is a schematic top view of a part of the eyeglasses, with different structural layers shown apart from one another, manufactured in accordance with the method of the invention,

FIG. 13 is a schematic side view of a part of second eyeglasses, with different structural layers shown apart from one another, manufactured in accordance with the method of the invention,

FIG. 14 shows schematically an oscillating microjet printer in the course of coating a substrate, and

FIG. 15 is a top view of completed coating produced by the microjet printer of FIG. 14.

For the sake of clarity, some embodiments of the invention are shown in a simplified manner in the figures. Like reference numerals refer to like parts in the figures.

### DETAILED DESCRIPTION OF SOME EMBODIMENTS OF THE INVENTION

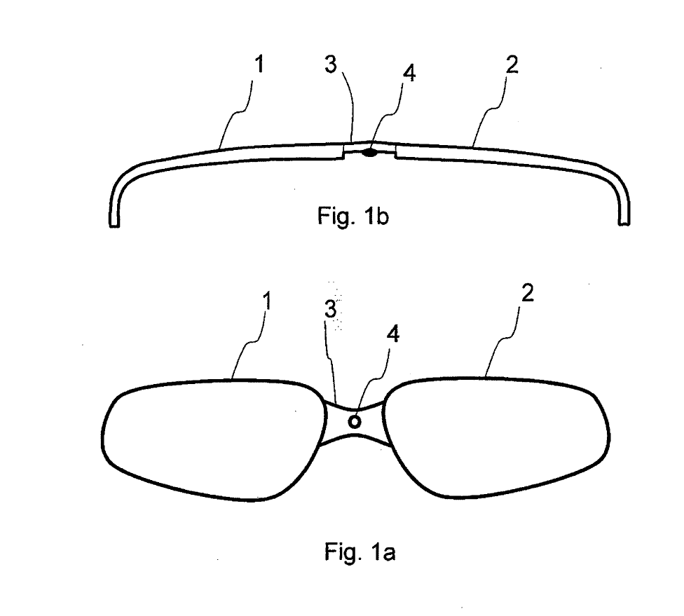

FIGS. 1a and 1b show schematically eyeglasses manufactured in accordance with the method of the invention.

The preform of the eyeglasses is made of plastic by injection moulding. The preform constitutes a carrying base part of the eyeglasses that may be coated, for instance, with appropriate coatings. The preform comprises optical lens areas 1 and 2 and a frame 3 connecting them. The optical lens areas 1 and 2 are an integral part of the frame 3. Thus, mutually integrated lenses and a frame connecting them are produced in one and the same injection moulding process. The lens area 1 is optically fully finished and its optical properties are not further affected, apart from coating. The lens area 1 may be designed such that it corrects refractive errors of the eye or the like. In a second embodiment the lens area 1 is machined with methods known per se for correcting refractive errors of the eye. In the injection moulding method it is possible, but not necessary, to inject material in a mould that is open to some extent, and after the injection the mould is closed by pressing. In that case it is possible to use materials having a very high molecular weight, which allow preparation of very hard and unstrained products.

After injection moulding the appearance of the eyeglasses may be modified, for instance, by milling, cutting and abrading.

Manufacturing material is plastic material of optically high quality, such as polyamide (e.g. PA12), polycarbonate or the like. Both optical areas, i.e. the lens areas 1 and 2, are physically connected to one another through a bridge 3. The bridge 3 is also the area, where an injection point 4 of an injection mould is preferably placed. The injection-moulded form and dimensions of the eyeglasses are preferably final, in other words, they need not necessarily require any further modifications to provide a new shape or size.

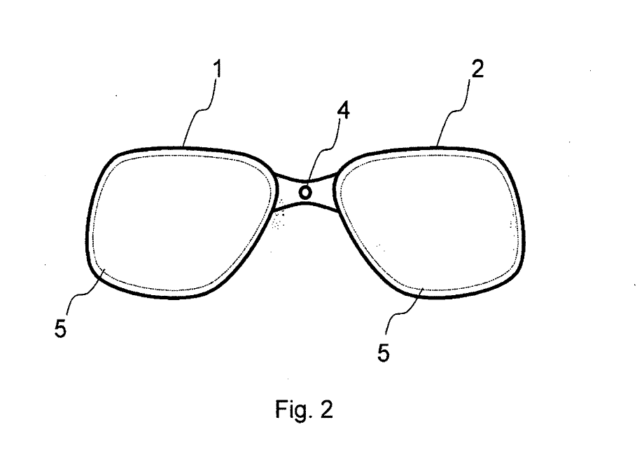

FIG. 2 is a schematic front view of second eyeglasses manufactured in accordance with the method of the invention. In this case the injection-moulded lens areas 1 and 2 are cut with a laser or a milling tool, for instance, to have shapes 5 surrounding the lens areas.

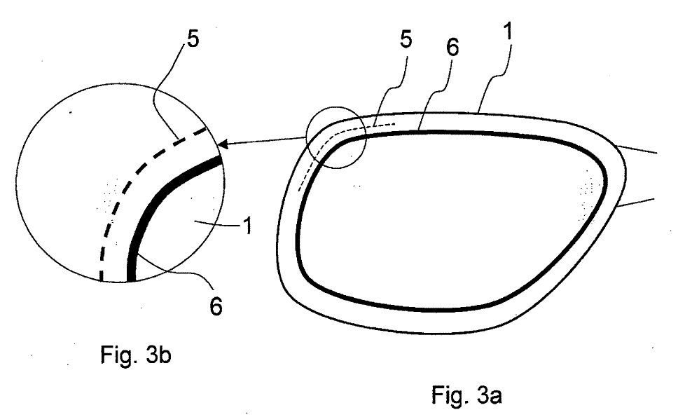

FIG. 3a and its partial enlargement 3b are schematic front views of third eyeglasses manufactured in accordance with the method of the invention. On an optical area 1 there is first placed a computer-controlled printing 6, for instance, in the form of a printed frame 6 and thereafter a new shape 5 is given with a milling tool, for instance. Generally speaking, the printing in accordance with the method of the invention is directed at least to lens areas. Prior to printing, the workpiece may have been coated by a coating method known per se.

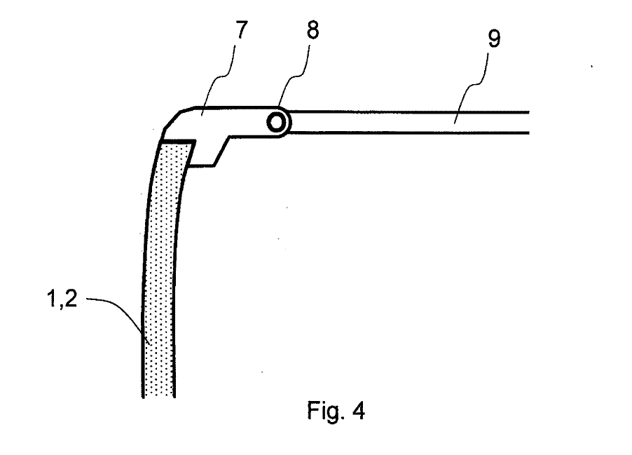

FIG. 4 is a schematic top view of a part of eyeglasses manufactured in accordance with the method of the invention. In this case the eyeglasses are provided with a separate temple area 7, in which there is arranged an actual temple piece 9 that is typically connected with a pin 8 to the temple area 7.

The temple area 7, which may also be called a separate frame, is connected to the optical area, i.e. the lens 1 and 2, by a connection method known per se, most preferably by laser welding.

Current methods to provide a separate temple area are mainly based on the use of metal parts that are connected with screws to the optical area or the use of plastic material that is glued to the optical area. Naturally, in that case the plastic materials have to be mutually compatible and of laser-weldable quality.

In applications that are of the type shown in FIGS. 1, 2 and 3 there is no actual need to produce a separate temple area 7, but it is most preferable to produce it simultaneously with the lenses 1 and 2 and the bridge 3 connecting them in the same injection moulding process. For reasons to give the eyeglasses a desired appearance it is possible to produce a separate temple area 7 that is joined in a separate process step to be a part of the actual eyeglasses which comprise the proper optical areas 1 and 2.

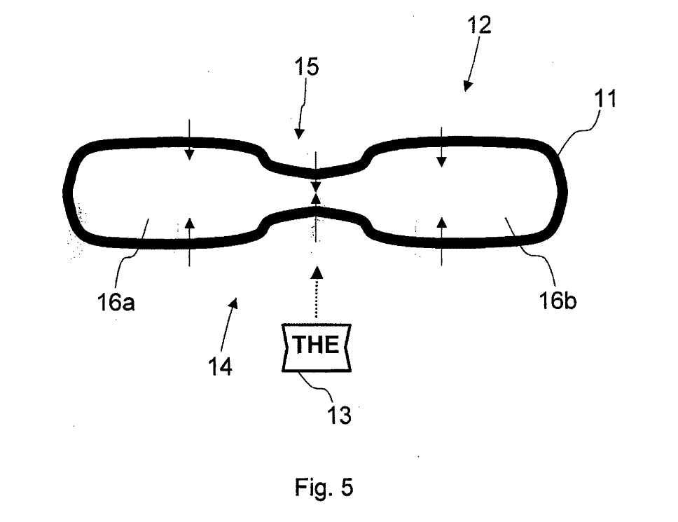

FIG. 5 is a schematic front view of the eyeglasses manufactured in accordance with fourth method of the invention. The frame 11 forms a continuous component made of viscous material, such as plastic material, such that the continuous, endless frame is movable at its centre 15 to allow expansion or shrinkage of the lens hole 16a and 16b.

Both sides 12 and 14 of the frame 11 may thus be distanced from one another such that the actual optical lens may be fitted in the enlarged holes 16a and 16b, whereafter the frame 11 is compressed at the centre 15 and eventually the halves 12 and 14 are interlocked with a connector 13. Thus, the lenses are pressed within the holes 16a and 16b in the frame 11. The fitting of the optical lens in the optical hole 16a and 16b is extremely easy in comparison with the known fixed frame constructions. The connector 13 may comprise a logo or other patterns, etc.

The frame 11 and a separate temple area 7 or a temple piece 9 optionally connected thereto are partly or completely coated or patterned with a computer-controlled microjet device, e.g. a one-colour or multicolour inkjet printer or a movable inkjet head thereof. Therefore all said parts may be produced in any colour or any pattern, for instance, to include a logo and colour of the person's own design. Said parts may thus be made of trans-parent plastic material and their appearance will be completely created with a computer-controlled inkjet printer method.

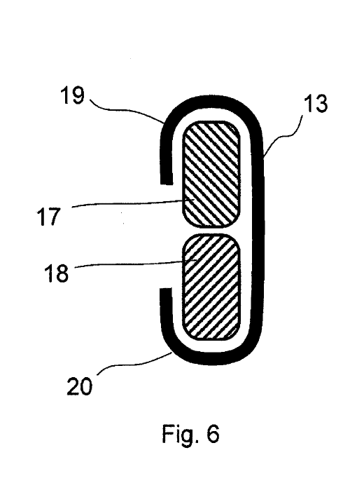

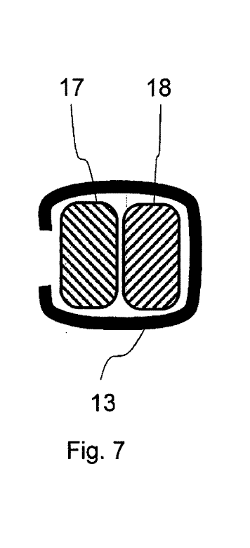

FIGS. 6 and 7 are schematic side views of some connector constructions. The connectors 13 comprise, for instance, coves 19 and 20 made of metal, arranged opposite one another and pressed around the frame parts 17 and 18.

Naturally, the connector 13 may also be of some other kind, for instance, one based on eccentricity, whereby revolution of the eccentric produces shrinkage of the holes 15 and 16 of the frame 11.

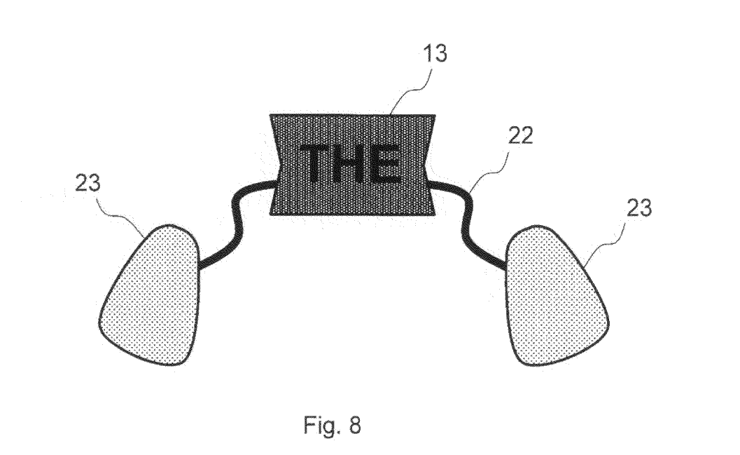

FIG. 8 is a schematic front view of a third connector construction. Nose pads 23 supported by wires 22 are secured to the connector.

Typically, it is not necessary to provide the injection-moulded frame with separate nose pads, but the corresponding forms are produced in the actual frame piece during the injection moulding process. An option for separate nose pads, however, enables novel design.

The connector 13 may be injection moulded of plastic material and optional nose pads 23 may be part of the moulded connector.

The connector 13 of FIG. 8 may be mounted on the injection-moulded eyeglasses of FIGS. 1 to 3 or on the injection-moulded frame of FIG. 5.

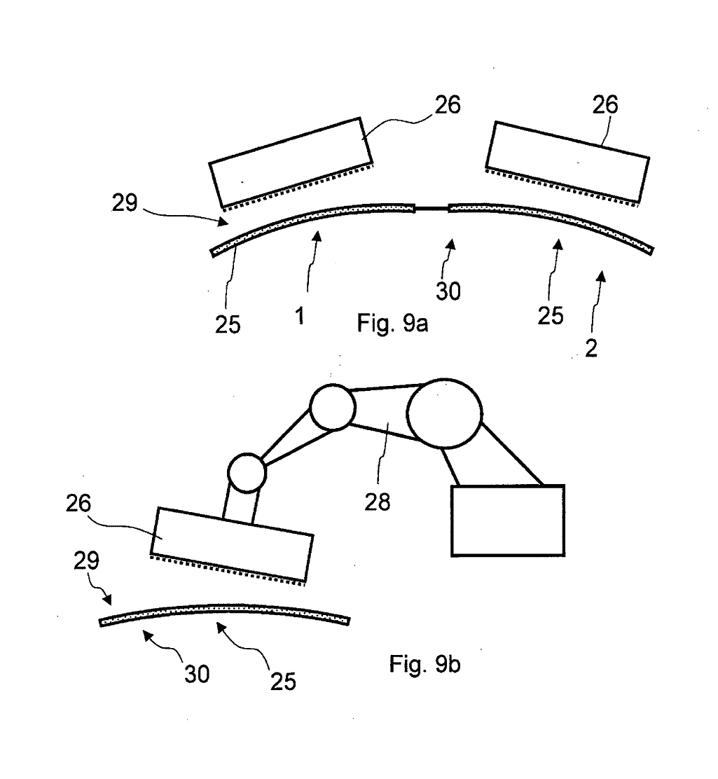

FIGS. 9a and 9b show schematically the principles of some steps in some embodiments of the methods in accordance with the invention. In the method steps concerned it is possible to coat eyeglasses of FIGS. 1 to 3, for instance.

In FIG. 9a, the cross section of the workpiece 25 is considerably curved. The workpiece, i.e. the preform, travels in linear motion past the microjet heads 26, the direction of the motion being that of the plane normal of the figure. The lenses 1 and 2 are coated on their first side 29 using two microjet heads 26 that are arranged side by side in the travel direction of the workpiece. The microjet heads 26 are mutually arranged on intersecting space planes. There may be a plurality of microjet heads 26 side by side. Even though it is not shown in FIG. 9a, it is obvious that the second side 30 of the lenses 1 and 2 may be coated using microjet heads arranged on this side and in mutual arrangement on intersecting space planes. The angles between the space planes are preferably adjustable in accordance with the form of the work piece.

It is possible to arrange a plurality of microjet heads 26 in succession in the travel direction of the workpiece. In that case all successive microjet heads 26 may coat the workpiece 25 with the same coating substance or through successive jetting heads it is possible to dispense various coating substances.

In the embodiment of FIG. 9b the microjet head 26 is arranged at the distal end of a computer-controlled robot arm 28. The arm may move the microjet head 26 following the forms of the workpiece 25, for instance, in a three- or five-axial manner.

Functional components of functional coatings are preferably incorporated in an organic varnish. The varnish may also contain inorganic components. The functional coatings denoted here include, for instance, IR block coatings, UV block coatings, hard coatings, photochromatic coatings and/or colour coatings. The functional coatings are preferably applied with a microjet method, which is computer-controlled and sprays the whole width of the workpiece in the same process. This microjet method is possible to implement, for instance, with an inkjet printer, such as Xaar 1001 inkjet head having a working width of 70 mm. In most cases this is sufficient to coat the whole width of the workpiece 25, because the width of the workpiece 25 is typically about 60 mm at most.

The coating may be provided either on one side of the workpiece 25 at a time or on both sides simultaneously.

By programming the coating software on a computer that controls the coating process it is possible to produce almost any decoration, logo, text, colour, colour gradient or the like onto the workpiece 25. In an embodiment of the invention the client may even design the appearance of his or her own product using his or her own computer. The client may have access to a software database of a manufacturing company or by using software adapted to the purpose the client may produce the necessary parameters, which determine all the characteristics of the product. The transfer of software tools and parameters may take place via the home page of the manufacturing company, for instance.

It is possible to produce a one-colour or multicolour surface that may be gradually darkening, i.e. a gradient surface. The colour may also vary in different places fully freely. For instance, it is possible to produce a four-colour image on the surface of the lens 1, 2.

In prior art technology a one-colour gradient coating is done with a separate colour pigment that is absorbed in the plastic material, for instance, in a lens 1, 2 made of plastic, or in a varnish layer placed thereon. The method used is a dipping method. The degree of dyeing, i.e. the degree of clearness or darkness, is adjusted as a function of time, i.e. the longer the product to be dyed resides in the dye vessel containing colouring agent, the stronger or darker the degree of dyeing. The product to be dyed is lifted off the dye vessel at a given rate, which may vary during the lifting. This makes it possible to achieve the exactly desired darkness and intensity of the colour.

In the present method the workpiece is dyed either with a colour pigment, which is in liquid form, or with a varnish, in which the dye is incorporated, and the varnish will be part of a hard coating. In the first mentioned application the coating is preferably carried out with a computercontrolled microjet printer in one or more colours, for instance in four colours, whereby an infinite number of colour variations will be obtained. A colour and darkness gradient is provided such that, in chronological order, first is coated the area in which strong dyeing is desired, and last is coated the area in which light dyeing is desired. Thus, the area to have a more intense colour is dyed for a longer period of time, i.e. more than the area of light dyeing. Finally, the whole surface is rinsed simultaneously to remove extra dye. Another preferable method for producing a colour and darkness gradient is to spray more dye on the area where a more intense colour is desired and less on the areas where a lighter colour is desired. In other words, the amount of colour pigment or dye is larger in the intensely coloured areas.

When the workpiece is dyed with pigment-containing varnish and the varnish will be part of a hard coating, computer-controlled printing is carried out by a microjet method. The colouring agent is mixed in an organic varnish which may also contain inorganic components. The thicker the coating, the darker or more intense the dyeing. If four-colour printing is used, any tone may be obtained by adjusting the dye ratios.

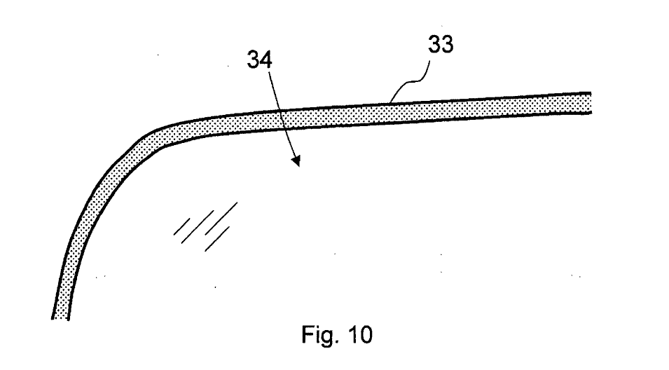

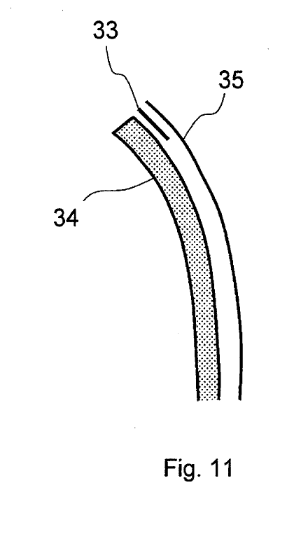

FIG. 10 is a schematic front view of a part of eyeglasses manufactured by the method of the invention, FIG. 11 is a cross-sectional top view of a part of second eyeglasses, which part is also manufactured by the method of the invention. In FIG. 11 different layers are shown apart from one another.

In the eyeglasses there is provided a frame area 33 in the optical area of the lens 34 with a microjet method, e.g. an inkjet printer head. The outline of the frame area 33 may be printed relatively freely. For instance, if the inkjet printer head comprises four colours, it is possible to print, i.e. form, a frame area 33 of any colour that constitutes a decorative area. Thus, it is possible to form frame areas 33 of any choice and colour, and all that under complete digital control. Thus, the eyeglasses may be personalized to have exactly the appearance the client desires. Reference numeral 35 denotes a hard coating.

The basic material of eyeglasses, i.e. the injection-moulded plastic, may be completely transparent and clear, which gives full freedom to dye or otherwise decorate the lens. It is also possible to use pre-dyed plastic having a 10-percent tone density, for instance. In the coating process the tone density may be augmented and provided with gradient.

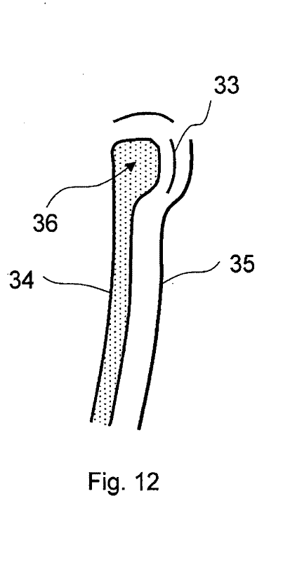

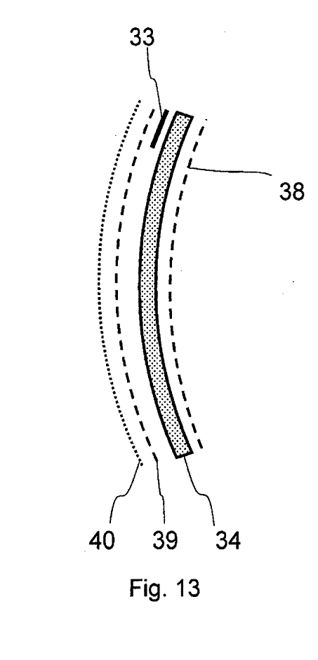

FIG. 12 is a schematic, cross-sectional top view of a part of the eyeglasses manufactured in accordance with the method of the invention, with different structural layers shown apart from one another and FIG. 13 is a schematic cross-sectional side view of a part of second eyeglasses manufactured in accordance with the method of the invention, with different structural layers shown apart from one another.

In the eyeglasses of FIG. 12 the frame area 33 is coated with a microjet device on the surface of a three-dimensional area locating on the rim area of the lens 34. The three-dimensional area 36 is made of the same material in the same injection moulding process as the proper lens 34, i.e. the optical area of the eyeglasses. Reference numeral 35 denotes hard coating.

FIG. 13 illustrates various functional surfaces which may be arranged on the surfaces of a transparent, undyed workpiece 34 made by injection moulding. The dye may be arranged either in the varnish that constitutes the outmost hard coating 40 or in the varnish that constitutes an IR block coating 38 on the inner side of the workpiece 34.

The workpiece 34 is thus not dyed by known dyeing methods in which the dye is absorbed in the plastic. It should be noted that a problem with the known dyeing method is that it only works with CR39-type thermoset plastic. For instance, a polyamide PA12 dyes very poorly or does not dye at all.

In FIG. 13, the product, e.g. sunglasses, is selectively coated. Selective coating means that on a first surface of the glasses there is a first functional coating arrangement, and correspondingly, on a second side there is a second functional coating arrangement whose functional characteristics are different from those of the first functional coating arrangement. The coating arrangement comprises one or more functional or decorative coating layers. The functional coating may be, for instance, a photochromatic coating, a hard coating, a dye coating, a dyed varnish coating, an antireflection coating, an IR block coating, a UV block coating, a gradient colour coating or an optical pattern coating. In the gradient colour coating, the colour gradually changes across the lens surface, for instance from light green to dark green. It is also possible to produce a gradient colour surface in which the colour gradually changes from one colour to another, for instance from green to blue. The functional coating may be a layer of varnish or primer.

The primer layer is a coating layer which is arranged between the workpiece, such as a lens, and the coating and which enhances the mutual adhesion thereof. The primer layer is used, for instance, because the surface chemistry of many plastic types is such that coatings will not adhere or adhere poorly thereto. Another reason for the use of a primer layer is that some plastic types do not tolerate solvents used in varnishes, whereby the primer layer protects the workpiece against the effect of the solvent. The primer layer may consist of urethane varnish or polyurethane, for instance. When the primer layer contains a component, e.g. a molecular chain, a chemical group, oxide or the like, that is the same or similar as in the coating layer to be applied on top of the primer layer, chemical, preferably covalent, bonds will be produced between the layers. A primer layer may also be used under a thick hard varnish layer of more than 5 μm, e.g. 10 μm, to prevent the hard varnish layer from detaching. In this case the primer layer forms an expansion-shrinkage layer between the workpiece and the hard coating that allows expansion between the workpiece and the hard coating of different thermal expansion coefficients.

In this connection it should be noted that a decorative coating refers here to coatings whose main purpose is to change the appearance of the eyeglasses. The decorative coating may form colours, patterns, logos, etc. The decorative coating may have functional purposes as well.

The actual workpiece 34 is colourless and the functions arranged therein are provided by functional coatings 38, 39 and 40. In the embodiment of FIG. 13, a photochromatic coating 39 is arranged under a hard coating and a basic colour, if any, is thus arranged in the hard coating 38 serving as an IR block coating. The darkness of the photochromatic coating is regulated by the effect of the intensity of radiation. The effect is expressly that the photochromatic coating lets through radiation of a certain wavelength or wavelength range the less the higher the intensity of the radiation concerned.

In addition, it is possible to produce a computer-controlled printing 33, for instance, by a microjet method with a static or oscillating inkjet printer head, for instance. The quality, number and positioning of the functional coatings on various sides of the workpiece may naturally differ from those shown in FIG. 13.

Various functional surfaces may be made of a varnish, e.g. siloxane, acrylate, urethane, epoxy or some other varnish, or a sol-gel coating. CR39, PC, PMMA, PS and PA are given here as examples of the workpiece materials. In the manufacturing material of the workpiece it is possible to mix a nanofiller, for about 3 to 10%, to improve the strength properties of the lens and the adhesion of the varnish. In that case the eyeglasses may comprise three superposed nanohardlayers: a) the workpiece, i.e. the lens, b) the varnish and c) the sol-gel surface.

One method of applying the coatings onto the surface of the workpiece is inkjet printing. That allows application of an extremely even and homogeneous layer as thin as 15 μm and without any upper limit for thickness, i.e. it is possible to produce extremely thin surfaces and, when necessary, also extremely thick surfaces.

Generally it is possible to use microjet methods, which may include:

1. commonly known inkjet printing

2. piezo-operated pressure jetting

3. piezo-operated line jetting

4. oscillating microjet printing

1. Inkjet printing. This is typically a system based on a piezo element and used for printing, in which each individual jet nozzle may be controlled independently and the size and number of each droplet may be adjusted with software. In a coating application this enables accurate, selective coating and accurate adjustment of variation in the thickness of a surface. Xaar XJ500 and Xaar XJ 1001 are given here as examples of these printers.

2. Piezo-operated pressure jetting, passive. Pressurized varnish is dispensed into droplets with a fast-operating piezo valve. In the actual nozzle module, all nozzles are supplied by a pump, through the valve, always at the same pressure simultaneously. The system is suitable for even surfaces, where the thickness of the surface to be produced is throughout constant. The pressure to be controlled by the piezo valve is very high, typically exceeding 10 MPa (100 bar), even up to 200 MPa (2000 bar).

3. Piezo-operated line jetting, active. Pre-pressurized varnish is dispensed into droplets at high rate in a nozzle module by means of a heavy-duty piezo element through several nozzles simultaneously, typically through more than five nozzle holes per one piezo element. The nozzles are divided into at least two nozzle modules, i.e. lines, each of which comprises at least two nozzles. Operation of the nozzle module may be controlled independently of the operation of other nozzle modules. The system is suitable for even surfaces, where the thickness of the surface to be produced is throughout constant. The actual jetting pressure is generated in the jetting module with a piezo element, so the pre-pressure need not be high, typically less than 10 MPa (100 bar).

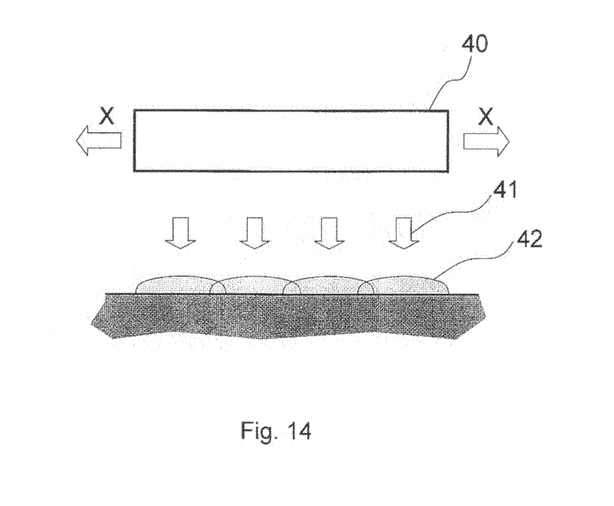

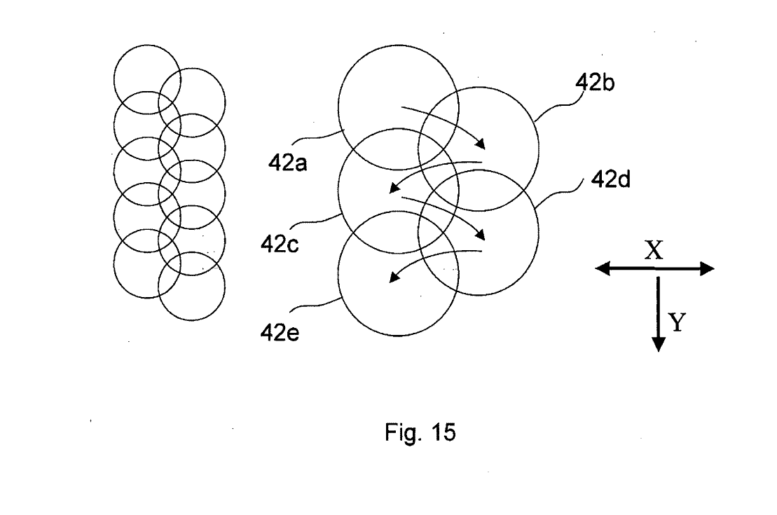

4. Oscillating microjet printing. This will be described in greater detail in connection with FIGS. 14 and 15.

All alternative jetting methods may include varnish heating that is integrated in the jetting head for enabling use of varnishes of high viscosity.

FIG. 14 shows schematically an oscillating microjet printer in the course of coating a substrate. A nozzle unit 40 oscillates in direction X, i.e. transversely to the travel direction Y of the substrate to be coated. The oscillation width is preferably at least ±0.01 mm to 2.0 mm, i.e. at least the distance between two nozzles. In that case the varnish droplets 42 will not only overlap (partly or completely) horizontally in direction X, but also in direction Y, i.e. vertically. This is shown in greater detail in FIG. 15. The oscillating frequency is chosen in range of, for instance, 1 to 100 000 Hz.

FIG. 15 is a schematic top view of a completed coating obtained by the microjet printer of FIG. 14. Oscillation in direction X combined with motion in direction Y, which is the travel direction of the substrate, i.e. the product, at the rate of 2 m/min, for instance, affects the morphological evenness of the coating produced and the general evenness of the surface alike.

After the first droplet 42a (sol-gel, varnish or any substance), due to oscillation and motion M, the next droplet 42b is slightly offset and partly covers the previous droplet 42a. Again, when the next droplet 42c is placed in this set, it will partly cover both droplet 42a and droplet 42b, etc. During transition in direction X it is possible to dispense one or more droplets from the nozzle onto the substrate. In the embodiment of FIG. 15 one droplet is dispensed in one direction.

In an embodiment of the invention oscillation of a nozzle unit 40 may be interrupted for a desired period of time, whereafter oscillation may be resumed. When necessary, the whole substrate may be coated using a non-oscillating nozzle unit 40. Oscillation, its width and/or frequency may be preferably adjusted and controlled with digital control means, which are known per se. This enables both production of extremely even surface of high optical quality and accurate definition of the area to be coated.

When applied with sol-gel coating an oscillating printer may produce very effective AR surfaces, because a thickness tolerance of ±1.25% is attainable in the thickness of the surface.

Likewise, the oscillating printer allows trouble-free application of thicker coatings, e.g. varnish coatings of 3 to 30 μm, even though they would contain nanofillers as optical varnish products always do. This is not attainable with known inkjet printers, because nanofillers, such as TiO₂, ZrO₂, Al₂O₃, TaO₅, SiO₂, oxides or ceramic nanofillers in general pack on the very spot where the printer nozzles place them. Addition of thinner will not help, because in that case the viscosity of the coating agent will be so low that it will run uncontrollably. Running on the coating area, in turn, means that the thickness of the surface is not constant, and consequently it cannot be used when producing optical or functional coatings.

Optimal viscosity for a coating substance is 9 to 20 cPs, the temperature of the coating substance being 20 to 30° C. The viscosity of the actual coating substance may be higher, for instance, 30 cPs at a temperature of 20° C., but the printer head may be provided with a heating element, wherewith the viscosity may be lowered to an optimal level of 9 to 15 cPs as the substance reaches the jetting nozzle. In that case the solvent content in the coating substance may be considerably lower and yet viscosity level required by the nozzle will be achieved.

It is advantageous that coating processes are fully automated and in the same integrated system. That is the easiest way to make sure the coating environment is sufficiently clean and the conditions are stable both for the coating and the hardening phase of the coatings. For instance, when two coating layers, e.g. a hard varnish and a sol-gel coating, are combined before their final hardening, the working environment and all parameters therein must be accurately controllable. That is to say that when the varnish is curing, air humidity, process temperature, temperature of the piece and other variables substantially affect the final result. For instance, if the varnish coat is excessively wet or excessively dry, the result is that covalent bonds will not be created between the two surfaces. Hence, it is advantageous that an integrated production system, if any, in which both a varnish coating and a sol-gel coating or a second varnish coating are arranged on the surface of the eyeglass preform, is at least partly closed from the environment. Thus the work processes may be carried out in an inert gas atmosphere, of which argon, nitrogen, xenon, helium and dry air are given as examples.

Hardening of the coatings that need hardening may be based, for instance, on a UV (Ultra Violet), MW (Micro Wave) or IR (Infra Red) method or thermal hardening. Each of these have their advantages, for instance, an advantage of the MW method is that its radiation affects immediately not only the surface to be hardened but also the interior of the coating and optional coatings underneath the topmost coating.

Various varnish coatings or varnish and sol-gel coatings may be attached to one another prior to final hardening of a lower coating. In other words, final hardening may be performed on various coatings at the same time. A lower coating may, of course, be hardened in part and/or it may be dried to let volatile solvents evaporate prior to arranging a next coating. In that case no adhesion layer or attachment layer between the coatings will be needed. Naturally, it is possible to perform final hardening on the lower coating prior to arranging a subsequent coating.

Different functionalities may be arranged in different surfaces. For instance, a photochromatic substrate may be mixed in a varnish that is applied on either one or both sides of the optical product. In a coating that blocks infrared radiation, i.e. thermal radiation, there is mixed ITO or ATO or another corresponding oxide or appropriate monomer in the varnish. In that case it is preferably placed on the side of the optical product that is opposite to the photochromatic coating.

Several molecules absorb light in the infrared zone having the wavelength of 800 to 1400 nm. As known, this property is utilized in chemical assays by means of an IR spectrometer. These molecules may be added to coatings without them disturbing a polymerization process or without them impeding travel of visible light. In principle, these molecules are found of two types: organic and inorganic. Inorganic, IR radiation absorbing molecules include: e.g. several alloyed metal oxides, sulphides and selenides. Their operating mechanism is based on transition of electrons. When IR radiation comes into contact with said molecules, the wavelength that corresponds to said difference in energy level is absorbed and slowly released. In this range the most common substance is ITO (Indium Tin Oxide). When a material of this kind is incorporated in an organic material or composite material, an individual particle must be of a nano size, preferably about 20 nm at most.

Organic, IR radiation absorbing materials are typically large molecules that are cis-trans-isomeric, i.e. ones in which a double bond may rotate into two different positions. The isomerization process may also be activated by energy originating from photons in the IR zone. Just like in inorganic molecules the energy is slowly released and the molecule resumes its original position. In this category the most commonly used molecule is phytochromobilin:

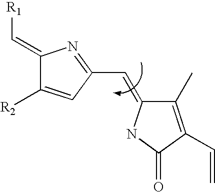

Phytochromobilin occurs naturally in some plants, in which it helps them to adapt to the sunlight. Phytochromobilin belongs to the tetrapyrrole family.

There are organic and inorganic photochromatic molecules. An inorganic molecule is the historical basis of photochromatic lenses. It is based on the capability of silver halides to absorb photons in the UV zone and to change to a relatively stable radical Ag*, which absorbs almost all the spectrum of visible light. This was originally commercialized by Cornig for their mineral lenses under trade name “Photogrey”. However, this phenomenon that acts perpetually does not allow implementation in plastic lenses, because the molecules used are not compatible with the organic base material. Consequently, only a material of nano size would be possible in order that lens cracking could be prevented. Surprisingly only nanoparticles of silver metal can have been synthesized. Therefore there has to be found novel means to prepare AgCl, AgBr or Agl nanoparticles. As long as this cannot be done, there is no known means to prepare a perpetually acting photochromatic plastic lens.

Organic molecules act differently. They are planar and large. In UV light they rotate and adopt a three-dimensional form. They may even open from a ring form to an open form. As a result the molecules thus change from colourless to coloured ones. This is illustrated in the following series of images.

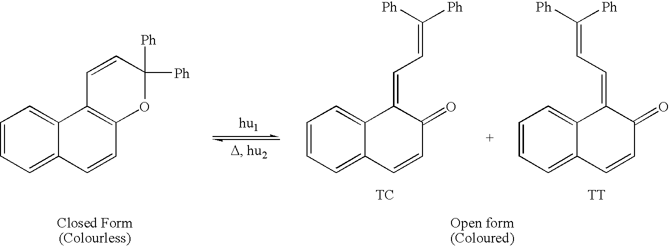

This molecule is called a naphtopyrane. However, this phenomenon is not perpetually reversible, unlike silver halides. The molecule is not capable of rotating infinitely but it fatigues with time. The activity of the molecule cannot be restored. It is possible to produce any colour with photochromatic dyes using these molecules.

In the material of the workpiece, i.e. in the injection-moulded plastic material, it is possible to incorporate nanoparticles, e.g. SiO₂, Al₂O₃, ZrO₂, etc. These improve surface hardness and mechanical characteristics of the plastic.

Generally, it may be stated that one object is to achieve as hard a surface as possible in a viscous substance, such as plastic, but yet retaining the good characteristics of the plastic, such as impact resistance, ready and simple formability, incorporation of added functions, etc. To put it briefly, the objective is to achieve the hardness of glass and the impact resistance of plastic at the same time.

Plastic in itself cannot be so hard as glass, e.g. Bk7 or quartz glass. It is known that to make the surface of plastic harder it is hard coated, for instance, with acrylate-, siloxane- or epoxy-based coatings, which are generally called varnishes. The coating method may be, for instance, a dip, airspray or spin-coat varnishing method or previously unknown digitally-controlled microjet methods.

If the object is to provide an extremely hard surface, e.g. quartz-like, but to retain the excellent characteristics of plastic, it is also necessary to affect the hardness characteristics of actual plastic. Irrespective of how hard the coating to be arranged onto the workpiece is, the coating may not be so thick that its characteristics alone could provide the surface hardness comparable to glass, when the surface is subjected to strain. The reason is that the thermal expansion coefficients of the plastic and the coating are so different that an excessively thick coating simply peels off. If the hard coating, such as siloxane varnish, is placed directly on the plastic, a typical maximum thickness is about 6 μm. Whereas, if a primer intermediate coating is used, e.g. urethane, polyurethene, epoxy, siloxane or a similar primer coating, the thickness of the hard coating may be increased to exceed 10 μm, for instance to 20 μm. A typical surface produced by dip varnishing is max. 4 μm thick. But, even though the coating would be very hard and its thickness would be 25 μm, for instance, which can be considered a very thick coating, the coating as such does not make the surface comparable to glass in hardness, when the coating is subjected to strain. The reason is that the substrate, i.e. the plastic, is soft. That is why the coating fails under strain. Only by affecting the hardness characteristics of the plastic it is possible to achieve an overall solution, which combines the desired good characteristics of glass and plastic.

Naturally, it is possible to affect the polymeric structure of the plastic, but it does not provide the necessary added value, and therefore the hardness is primarily produced with certain fillers that are incorporated in the plastic raw material. It is known per se to incorporate inorganic fillers in an organic, viscous substance, such as plastic and varnishes. For instance, glass fibres and glass fillers have always been mixed into plastic. Likewise, quartz, i.e. glass, nanoparticles have been incorporated in varnishes to increase hardness, or titanium oxide particles to amend the refraction index. A problem arises that when nanoparticles, whose size is about 10 to 30 nm, are incorporated either in plastic or in varnish, they tend to cluster, i.e. they agglomerate into unformed groups. When a varnish is concerned, the problem may be solved by coating the nanoparticles, e.g. SiO₂ particles of 20 nm, with a slime coating, for instance. The nanoparticles coated in this manner may be incorporated directly in the varnish, for instance. When plastic is concerned, a problem may be that the nanoparticles do not distribute evenly in plastic material that is in dry, e.g. granulate or powder, form.

Nanoparticles, whether coated or not, preferably coated, however, are most preferably mixed into the plastic raw material in so-called wet step. For instance, for polycarbonate (PC) and epoxy it would mean that in the preparation process of plastic the nanoparticle is incorporated in one of its components, for instance, in a BISFENOL-A component. This allows preparation of a plastic type having a completely homogeneous composition and including nanoparticles. A workpiece made of plastic of this type may be coated with a coating having a completely homogeneously distributed nanoparticle mass. Thanks to the homogeneity the thickness of a coating layer is accurate and it may be 5 μm, most preferably 10 μm. By means of the microjet method it is possible to obtain an optimal surface thickness with the thickness tolerance of less than ±5%, most preferably ±1% for the whole surface.

In addition to oxides, the fillers may also be CNT (Carbon Nano Tube), i.e. carbon nanotubes or fulierenes, e.g. C₆₀, which in the most preferable form are coated to prevent clustering. It is preferable, if the plastic to be coated and the coating substance contain the same nanofiller material. In that case in the course of the process it is possible to produce advantageously covalent bonds between the piece and the coating. An application of the method is that nanofillers are added to the plastic, nanofillers are incorporated in the varnish and that the thickness of the coating made thereof is more than 5 μm, most preferably more than 10 μm and that the thickness tolerance is less than ±5%, most preferably less than ±1% and further that the application method of the varnish or sol-gel coating is a microjet printing method.

In some cases the features described in this document may be employed as such, irrespective of other features. On the other hand, the features described in this document may be combined, when necessary, to obtain various combinations.

The drawings and the relating description are only intended to illustrate the inventive idea. The details of the invention may vary within the scope of the claims.

1.-9. (canceled)

10. A method for manufacturing eyeglasses, the method comprising injection moulding a preform for eyeglasses of transparent plastic, the preform comprising lens areas and a frame in seamless arrangement therewith that connects said lens areas, performing a computer-controlled printing on the preform for providing one or more functional and/or decorative coatings, the printing being directed at least to the lens areas, and directing the computer-controlled printing also to the frame for printing the outline of a frame area.

11. The method of claim 1, wherein the printing employs a microjet printer.

12. The method of claim 2, wherein the microjet printer is an oscillating microjet printer.

13. The method of claim 1, comprising coating by at least one functional coating selected from a photochromatic coating, a hard coating, a dye coating, a dyed varnish coating, an anti reflection coating, an IR block coating, a UV block coating, a gradient colour surface or an optical pattern surface.

14. The method of claim 1, comprising coating on the rim zone of the lens parts a decorative coating that creates an impression of an eyeglass frame.

15. The method of claim 1, comprising coating a first side of the workpiece with coatings that are different from those of a second side.

16. The method of claim 1, comprising arranging at least two superposed coatings and carrying out their final hardening simultaneously.

17. The method of claim 1, comprising hardening the coatings with microwaves.

18. A method for manufacturing eyeglasses, the method comprising injection moulding an eyeglass frame, which forms a continuous, endless and elastic component around the lens holes, the lens holes being compressible around the lenses fitted in the lens holes and performing a computer-controlled printing on the frame for providing one or more functional and/or decorative coatings.
